(19) United States
(12) Patent Application Publication
(10) Pub. No.: US 2026/0188533 A1
(43) Pub. Date: Jul. 2, 2026

(54) METAL INJECTION SYSTEM USING ELECTROLYSIS OF METAL IN A NUCLEAR POWER PLANT

(71) Applicant: GE-Hitachi Nuclear Energy Americas LLC, Wilmington, NC (US)

(72) Inventor: Toyoaki MIYAZAKI, Danville, CA (US)

(73) Assignee: GE-Hitachi Nuclear Energy Americas LLC, Wilmington, NC (US)

(21) Appl. No.: 19/005,310

(22) Filed: Dec. 30, 2024

(51) Int. Cl. G21C 19/30

(52) U.S. Cl. CPC G21C 19/30

(57) ABSTRACT

A metal injection system configured to release metal particles into a coolant, the coolant configured to be an electrolyte, through cycling a voltage applied to the electrodes including a metal such that the metal degrades into the metal particles enabling the electrolyte to carry the metal particles through at least a portion of nuclear process equipment to further enable deposition of the metal particles at a nuclear process equipment surface that is exposed to the electrolyte.

### BACKGROUND

Online metal injection is used in nuclear power plants to protect stainless and nickel-alloy steel process devices in nuclear power plants from stress corrosion cracking.

Nuclear power plants may circulate a transfer fluid (e.g., a process fluid, working fluid, coolant, etc.) into and out of nuclear process equipment associated with a nuclear reactor, for example pressure vessels, conduits, piping, or the like. For example, a nuclear reactor may include a pressure vessel that encloses a nuclear reactor core. The nuclear reactor may be configured to circulate a coolant (e.g., water or the like) into and/or out of the reactor pressure vessel.

The coolant (e.g., water) may be oxidizing due to radiolytic generation of oxidizing species such as oxygen and/or hydrogen peroxide. Such an oxidizing environment may elevate the electrochemical corrosion potential of surfaces and/or equipment exposed to the fluid and increase the likelihood of stress corrosion cracking in such equipment and/or surfaces, for example the reactor pressure vessel. To reduce such cracking, a metal may be injected into the coolant to coat the nuclear process equipment and/or surfaces through electroplating or electroless plating to recombine hydrogen and oxidants.

### SUMMARY

Some example embodiments may include a metal injection system configured to release metal particles into a coolant configured to be an electrolyte to enable the electrolyte to carry the metal particles through at least a portion of nuclear process equipment to further enable deposition of the metal particles at a nuclear process equipment surface that is exposed to the electrolyte. The metal injection system may include at least two electrodes, at least one electrode of the at least two electrodes including the metal, the at least one electrode configured to be exposed in flow communication with at least a portion of an electrolyte flow pathway that is at least partially defined by the nuclear process equipment surface of the nuclear process equipment and is configured to circulate the electrolyte to contact the nuclear process equipment surface of the nuclear process equipment, such that the at least one electrode is configured to be contacted by at least a portion of the electrolyte flowing through the electrolyte flow pathway to further flow in fluid communication with the nuclear process equipment surface; a power source connected to each electrode of the at least two electrodes; and a controller configured to control a voltage of electrical power applied from the power source to the at least two electrodes, the controller is configured to cycle the voltage between a first voltage and a second voltage over a period of time to induce separation of at least one metal particle from the at least one electrode into the electrolyte contacting the at least one electrode, the second voltage being greater than the first voltage, the cycling including increasing the applied voltage from the first voltage to the second voltage to cause at least a portion of the metal of the at least one electrode to oxidize to form a metal oxide, and decreasing the applied voltage from the second voltage to the first voltage subsequently to increasing the applied voltage from the first voltage to the second voltage and concurrently with the electrolyte contacting the at least one electrode to cause at least a portion of the metal oxide to reduce to metal and to separate from the at least one electrode into the electrolyte as the at least one metal particle.

In some example embodiments, the second voltage is in a range of greater than or equal to 1.0 V to less than or equal to 5 V, and the first voltage is less than or equal to 0.8 V.

In some example embodiments, the controller is configured to cycle the voltage from the power source to the at least two electrodes in a triangle wave pattern.

In some example embodiments, the controller is configured to cycle the voltage between the first voltage and the second voltage at a rate of voltage change in a range of 1 mV/s to 1 V/s.

In some example embodiments, the metal includes at least one of platinum, gold, palladium, rhodium, ruthenium, osmium, silver, iridium, titanium, zinc, nickel, iron, or any combination thereof.

In some example embodiments, the metal includes platinum.

Some example embodiments include a nuclear power plant including nuclear reactor, the nuclear reactor including nuclear reactor process equipment, the nuclear reactor process equipment including at least one of a reactor pressure vessel or a nuclear reactor core within the reactor pressure vessel, the nuclear reactor process equipment including a nuclear reactor process equipment surface at least partially defining an electrolyte flow pathway extending at least partially through the nuclear reactor, the nuclear reactor process equipment configured to circulate a coolant configured to be an electrolyte through the electrolyte flow pathway to contact the nuclear reactor process equipment surface; and the metal injection system of claim 1, wherein the at least one electrode of the metal injection system is exposed to at least a portion of the electrolyte flow pathway such that the nuclear power plant is configured to circulate at least a portion of the electrolyte to flow in contact with the at least one electrode, the electrolyte flow pathway includes a coolant circuit configured to circulate the coolant through the nuclear reactor, wherein the controller of the metal injection system is configured to cycle the voltage between the first voltage and the second voltage over the period of time, concurrently with the electrolyte circulating through the coolant circuit, to induce separation of the at least one metal particle from the at least one electrode into the electrolyte contacting the at least one electrode and to further cause the at least one metal particle to deposit at at least one nuclear reactor process equipment surface based on the electrolyte carrying the at least one metal particle through at least a portion of the coolant circuit.

In some example embodiments, the at least two electrodes are within the reactor pressure vessel.

In some example embodiments, the controller is within the reactor pressure vessel.

In some example embodiments, the coolant is water, and the nuclear power plant is configured to circulate the water through the coolant circuit such that a temperature of water in contact with the at least one electrode is equal to a temperature of water entering the reactor pressure vessel.

In some example embodiments, the nuclear power plant includes at least two flow control valves are configured to be operated to isolate the at least one electrode from at least a portion of the electrolyte flow pathway and the nuclear reactor process equipment.

In some example embodiments, the coolant circuit includes a feedwater pipe configured to direct coolant into the reactor pressure vessel, and the at least one electrode is within the feedwater pipe.

In some example embodiments, the nuclear reactor is a boiling water reactor.

In some example embodiments, the nuclear reactor is a pressurized water reactor.

In some example embodiments, the water in contact with the at least one electrode is at a temperature between 220° C. and 340° C.

In some example embodiments, the at least two electrodes have a combined surface area that is between 1 m² and 200 m².

In some example embodiments, a distance between opposing immediately-adjacent surfaces of the at least two electrodes is between 1 mm and 10 cm.

Som example embodiments include method of releasing metal particles into a coolant configured to be an electrolyte such that the coolant is configured to carry the metal particles through at least a portion of nuclear process equipment to further enable deposition of the metal particles at at least one at least one nuclear process equipment surface of the nuclear process equipment that is exposed to the electrolyte. In some example embodiments, the method of releasing the metal particles includes contacting at least two electrodes with the electrolyte within an electrolyte flow pathway that is at least partially defined by the at least one nuclear process equipment surface of the nuclear process equipment, at least one electrode of the at least two electrodes including the metal; circulating the electrolyte through the electrolyte flow pathway such that the at least two electrodes are contacted by the electrolyte flowing through the electrolyte flow pathway and the electrolyte flowing through the electrolyte flow pathway are in fluid communication with the at least one nuclear process equipment surface; applying a voltage of electrical power to the at least two electrodes from a power source connected to each electrode of the at least two electrodes; and controlling the voltage of electrical power applied from the power source to the at least two electrodes such that the voltage cycles between a first voltage and a second voltage over a period of time to induce separation of at least one metal particle from the at least one electrode into the electrolyte contacting the at least one electrode, the second voltage being greater than the first voltage, the cycling including, increasing the applied voltage from the first voltage to the second voltage to cause at least a portion of the metal of the at least one electrode to oxidize to form a metal oxide, and decreasing the applied voltage from the second voltage to the first voltage subsequently to increasing the applied voltage from the first voltage to the second voltage and concurrently with the electrolyte contacting the at least one electrode to cause at least a portion of the metal oxide to reduce to metal and to separate from the at least one electrode into the electrolyte as the at least one metal particle.

In some example embodiments, the second voltage is in a range of greater than or equal to 1.0 V to less than or equal to 5 V, and the first voltage is less than or equal to 0.8 V.

In some example embodiments, the cycling includes cycling the voltage in a triangle wave pattern.

In some example embodiments, the controlling includes cycling the voltage between the first voltage and the second voltage at a rate of voltage change in a range of 1 mV/s to 1 V/s.

In some example embodiments, the metal includes at least one of platinum, gold, palladium, rhodium, ruthenium, osmium, silver, iridium, titanium, zinc, nickel, iron, or any combination thereof.

In some example embodiments, the metal includes platinum.

In some example embodiments, the circulating and the controlling are performed concurrently to induce separation of the at least one metal particle from the at least one electrode into the electrolyte contacting the at least one electrode and to further cause the at least one metal particle to deposit at the at least one nuclear process equipment surface based on the electrolyte carrying the at least one metal particle through at least a portion of the electrolyte flow pathway.

In some example embodiments, the nuclear process equipment includes a nuclear reactor, the nuclear reactor including at least one of a reactor pressure vessel or a nuclear reactor core within the reactor pressure vessel, the electrolyte flow pathway includes a coolant circuit that circulates a coolant through the nuclear reactor, the electrolyte includes the coolant within the coolant circuit, the at least one nuclear process equipment surface includes a nuclear reactor surface of the nuclear reactor that is exposed to the coolant based on circulation of the coolant through the nuclear reactor, and the controller cycles the voltage between the first voltage and the second voltage over the period of time, concurrently with the coolant circulating through the coolant circuit, inducing separation of the at least one metal particle from the at least one electrode into the coolant contacting the at least two electrodes and further cause the at least one metal particle to deposit at the nuclear reactor surface based on the coolant carrying the at least one metal particle through at least a portion of the nuclear reactor.

In some example embodiments, the at least two electrodes are within the reactor pressure vessel.

In some example embodiments, the controller is within the reactor pressure vessel.

In some example embodiments, the nuclear reactor is a boiling water reactor.

In some example embodiments, the nuclear reactor is a pressurized water reactor.

In some example embodiments, the coolant is water, and the water in contact with the at least two electrodes is at a temperature between 220° C. and 340° C.

In some example embodiments, the coolant circuit includes a feedwater pipe configured to direct coolant into the reactor pressure vessel, and the at least two electrodes are within the feedwater pipe.

In some example embodiments, the at least two electrodes have a combined surface area that is between 1 m² and 200 m².

In some example embodiments, a distance between opposing immediately-adjacent surfaces of the at least two electrodes is between 1 mm and 10 cm.

Some example embodiments include a method for assembling a metal injection system. In some example embodiments the method includes obtaining a metal injection system configured to release at least one metal particle into a coolant configured to be an electrolyte such that the coolant is configured to carry the at least one metal particle through at least a portion of nuclear process equipment to further enable deposition of the at least one metal particle at at least one nuclear process equipment surface of the nuclear process equipment that is exposed to the electrolyte for use in a nuclear power plant; and inserting the metal injection system into a coolant circuit for the nuclear power plant, the metal injection system including, at least two electrodes, at least one electrode of the at least two electrodes including the metal, the at least one electrode configured to be exposed in flow communication with at least a portion of an electrolyte flow pathway that is at least partially defined by the at least one nuclear process equipment surface of the nuclear process equipment and is configured to circulate the electrolyte to contact the at least one nuclear process equipment surface of the nuclear process equipment, such that the at least one electrode is configured to be contacted by at least a portion of the electrolyte flowing through the electrolyte flow pathway to further flow in fluid communication with the at least one nuclear process equipment surface, a power source connected to each electrode of the at least two electrodes; and a controller configured to control a voltage of electrical power applied from the power source to the at least two electrodes, the controller is configured to cycle the voltage between a first voltage and a second voltage over a period of time to induce separation of at least one metal particle from the at least one electrode into the electrolyte contacting the at least one electrode, the second voltage being greater than the first voltage, the cycling including increasing the applied voltage from the first voltage to the second voltage to cause at least a portion of the metal of the at least one electrode to oxidize to form a metal oxide, and decreasing the applied voltage from the second voltage to the first voltage subsequently to increasing the applied voltage from the first voltage to the second voltage and concurrently with the electrolyte contacting the at least one electrode to cause at least a portion of the metal oxide to reduce to metal and to separate from the at least one electrode into the electrolyte as the at least one metal particle.

A metal injection system according to some example embodiments may include a passive or active metal injection system implementing a long-lasting metal source reducing storage costs. A metal injection system according to some example embodiments may include a passive or active system that introduces the metal at process conditions reducing additional nuclear process equipment. A metal system according to some example embodiments may include a passive or active system that introduces the metal without further introducing elements that increase the conductivity of the coolant environment.

A passive metal injection system may reduce or minimize external interaction to release a metal into the operating system once the passive system has been implemented in the industrial process system. Accordingly, a metal injection system according to some example embodiments may reduce the expenses and labor associated with storing and handling such traditional metal injection systems while providing the metal to the coolant such that a likelihood of stress corrosion cracking is reduced.

A metal injection system according to some example embodiments may not use any carrier solution to introduce the metal into the coolant. Accordingly, a metal injection system according to some example embodiments may the metal to the coolant and thereby reduce a likelihood of stress corrosion cracking without introducing additional conductive materials (e.g., Na) that would increase a likelihood of stress corrosion cracking.

A metal injection system according to some example embodiments may introduce the metal at nuclear process conditions. Therefore, such a metal injection system reduce or minimize additional process equipment (e.g., heat exchangers, pressure vessels, pressure release valves, pumps etc.) necessary to adjust nuclear process conditions amiable to introducing the metal into the process.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a schematic layout of a nuclear power plant including a metal injection system according to some example embodiments.

FIG. 2A is a schematic layout depicting a location of a metal injection system in a coolant circuit according to some example embodiments.

FIG. 2B is a schematic layout depicting a location of a metal injection system in a coolant circuit according to some example embodiments.

FIG. 2C is a schematic layout depicting a location of a metal injection system in a coolant circuit according to some example embodiments.

FIG. 3 is a schematic layout depicting an active metal injection system in an oxidized state according to some example embodiments.

FIG. 4 is a schematic layout depicting an active metal injection system in a reduced state according to some example embodiments.

FIG. 5 is a voltage vs time graph depicting a voltage applied to an electrode in an active metal injection system according to some example embodiments.

FIG. 6 is a schematic layout depicting a passive metal injection system according to some example embodiments.

FIG. 7 is a schematic layout depicting a passive metal injection system implementing a porous carrier according to some example embodiments.

FIG. 8 is a schematic layout depicting the coating of process equipment according to some example embodiments.

FIG. 9 is a flow chart depicting a method of operating an active metal injection system according to some example embodiments.

FIG. 10 is a flow chart depicting a method of operating a passive metal injection system according to some example embodiments.

### DETAILED DESCRIPTION

Hereinafter, some example embodiments will be explained in detail with reference to the accompanying drawings. Like numbers refer to like elements throughout the specification. In flowcharts described with reference to the drawings, the order of operations may be changed, several operations may be merged, certain operations may be divided, and certain operations may not be performed.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

It will be understood that elements and/or properties thereof may be recited herein as being “identical”, “the same”, or “equal” as other elements and/or properties thereof, and it will be further understood that elements and/or properties thereof recited herein as being “identical” to, “the same” as, or “equal” to other elements and/or properties thereof may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to, equal to or substantially equal to, and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element or property is referred to as being identical to, equal to, or the same as another element or property, it should be understood that the element or property is the same as another element or property within a desired manufacturing or operational tolerance range (e.g., ±10%).

It will be understood that elements and/or properties thereof described herein as being “substantially” the same, equal, and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

Although described with reference to specific examples and drawings, modifications, additions, and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

It will be understood that a “nuclear reactor” as described herein may include any or all of the well-known components of a nuclear reactor, including a nuclear reactor core with or without nuclear fuel components, control rods, or the like. It will be understood that a nuclear reactor as described herein may include any type of nuclear reactor, including but not limited to a Boiling Water Reactor (BWR), a Pressurized Water Reactor (PWR), a liquid metal cooled reactor, a Molten Salt Reactor (MSR), or the like. As described herein, a nuclear reactor may include an Advanced Boiling Water Reactor (ABWR), an Economic Simplified Boiling Water Reactor (ESBWR), a BWRX-300 reactor, or the like.

It will be understood that a “fluid,” “coolant fluid,” or “coolant” as described herein may include any well-known coolant fluid that may be used in cooling any part of a nuclear plant and/or nuclear reactor, including water, a liquid metal (e.g., liquid sodium), a gas (e.g., helium), a molten salt, any combination thereof, or the like. It will be understood that a “fluid” as described herein may include a gas, a liquid, or any combination thereof.

The present inventive concepts relate to active and/or passive metal injection systems and methods of implementing such systems in a nuclear power plant. An active metal injection system may be controlled by an operator, or any other method of control, for example an electronic controller, to control a rate of release of the metal into an industrial process system. A passive metal injection system may reduce or minimize additional external interaction to release a metal into the operating system once the passive system has been implemented in the nuclear power plant.

The metal injection system according to some example embodiments may replace the use of traditional metal injection systems (e.g., metal injection systems that rely on sodium hexahydroxyplatinate (IV)). A metal injection system according to some example embodiments may reduce the expenses and labor associated with storing, handling, and/or operating such traditional metal injection systems while continuously providing the metal to the coolant such that a likelihood of stress corrosion cracking is reduced.

Existing methods of metal injection may implement carrier solutions (e.g., sodium hexahydroxyplatinate (IV)) that release metals into the coolant. However, such carrier solutions may be unstable at ambient conditions and therefore, may be difficult to store and/or handle. Additionally, such solutions may dissolve rapidly at process conditions and/or use additional process equipment to introduce the solution at process conditions. Therefore, such solutions may use additional process equipment, for example heat exchangers and/or pumps to lower and/or raise the temperature and/or pressure of the coolant environment where the carrier solution is introduced, to implement the carrier solution. Moreover, such carrier solutions may introduce additional elements into the process equipment. For example, sodium hexahydroxyplatinate (IV) may introduce sodium into the coolant, thereby increasing the conductivity of the coolant. As a result, the rate of cracking in the process equipment exposed to the fluid may increase.

The metal injection system according to some example embodiments may release metal into a coolant environment without using a carrier solution (e.g., without using any liquid carrier solution) to introduce metal into the coolant environment. Carrier solutions (which as described herein may be liquid carrier solutions) may introduce additional components other than the metal into the coolant (e.g., Na) that may increase the conductivity of the coolant, and thereby increase a likelihood of stress corrosion cracking. Therefore, a metal injection system according to some example embodiments may introduce the metal directly to the coolant without any carrier solution and thereby reduce a likelihood of stress corrosion cracking without introducing additional conductive materials (e.g., Na) and thus may reduce a likelihood of stress corrosion cracking.

The metal injection system according to some example embodiments may be a passive metal injection system. Accordingly, such a system may reduce or minimize additional labor used to operate the system to implement metal introduction into the coolant, or may be configured to operate to implement the metal introduction without any additional labor (e.g., operate automatically, autonomously, etc.). The metal injection system according to some example embodiments may be an automatic process that continues without external stimulus once the metal injection system is introduced into the nuclear power plant and the nuclear power plant is operating. Therefore, a metal injection system according to some example embodiments may reduce down time or stoppages to introduce metal into the coolant.

The metal injection system according to some example embodiments may be an active metal injection system. Accordingly, such a system may allow for active control of the rate of release of the metal into the nuclear power plant.

The metal injection system according to some example embodiments may introduce the metal into the coolant at process conditions. Process conditions as used herein, unless otherwise explicitly stated, refers to the temperature and pressure of a coolant entering a reactor pressure vessel while the nuclear power plant is in operation. Therefore, such a metal injection system may be configured to release metal particles into the process system with reduced or minimized additional process equipment (e.g., heat exchangers, pressure vessels, pressure release valves, pumps etc.) to adjust process conditions amiable to introducing the metal into the process.

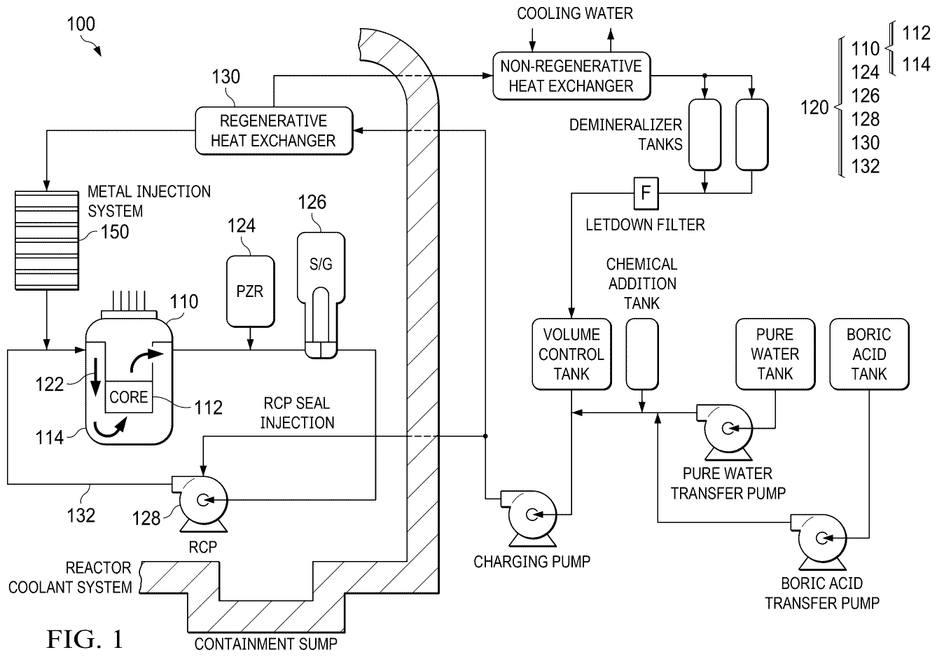

FIG. 1 is a schematic layout of a nuclear power plant including a metal injection system according to some example embodiments.

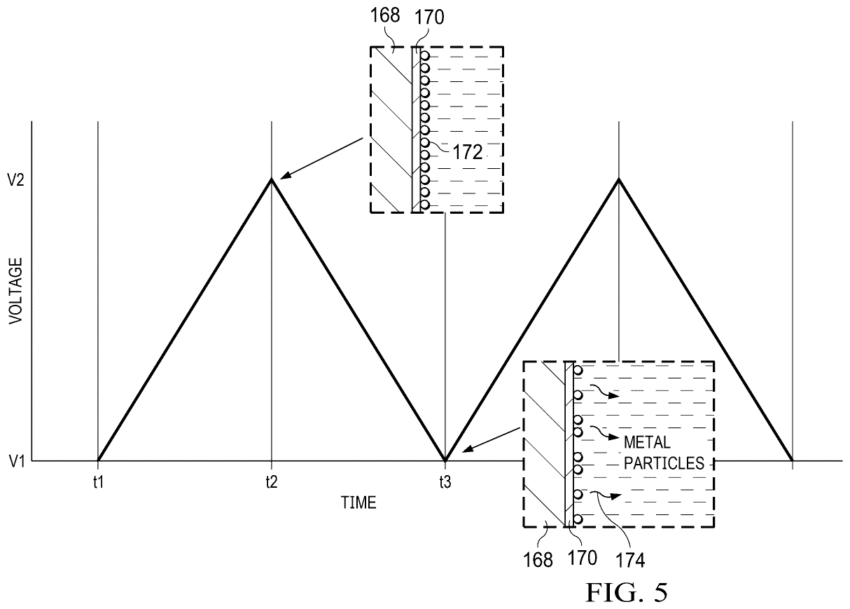

Referring to FIG. 1, some example embodiments of a nuclear power plant 100 may include a nuclear reactor 110 including a reactor core 112 and a reactor pressure vessel 114. The nuclear power plant 100 may include a coolant circuit 120 that is configured to circulate a coolant 122 through the coolant circuit 120 and thereby expose the coolant 122 to the nuclear reactor 110. In some example embodiments the coolant 122 may be an electrolyte. As used herein an electrolyte refers to a substance that conducts electricity through the movement of ions. In some example embodiments, the coolant 122 may be capable of oxidizing metals. As used herein oxidizing refers to the process of accepting or receiving electrons from another material (e.g., a metal) in a redox reaction. For example, the coolant 122 may be an electrolyte that produces oxidizing compounds in response to a voltage (e.g., a larger voltage, see FIG. 5 for a detailed description) passing through the coolant 122. The coolant 122 may be configured to transfer heat generated by the reactor core 112 away from the nuclear reactor 110. For example, heat generated in the reactor core 112 may be transferred through the reactor pressure vessel 114 from the reactor core 112 into the coolant 122 flowing into the nuclear reactor 110. The coolant 122 may subsequently exit the nuclear reactor 110 and utilize the heat either directly or indirectly through transfer to a subsequent fluid (e.g., steam generation).

In some example embodiments, the coolant circuit 120 may be defined by nuclear process equipment configured to cycle coolant 122 through the coolant circuit 120 such that the coolant transfers heat away from the nuclear reactor 110. For example, the coolant circuit 120 may include, but is not limited to pumps, pressurizers, steam generators, heat exchangers, pressure vessels, throttle valves, turbines etc.

The example embodiments of a coolant circuit 120 depicted in FIG. 1 may include a pressurizer 124, a steam generator 126, a pump 128, a heat exchanger 130, and a feedwater pipe 132. However, the example embodiments are not so limited thereto. For example, FIG. 1 depicts some example embodiments of a pressurized water reactor (“PWR”), however, the example embodiments are not so limited thereto. For example, the nuclear power plant 100 may include a Boiling Water Reactor (BWR), a Pressurized Water Reactor (PWR), a liquid metal cooled reactor, a Molten Salt Reactor (MSR), or the like. As described herein, a nuclear reactor may include an Advanced Boiling Water Reactor (ABWR), an Economic Simplified Boiling Water Reactor (ESBWR), a BWRX-300 reactor, or the like.

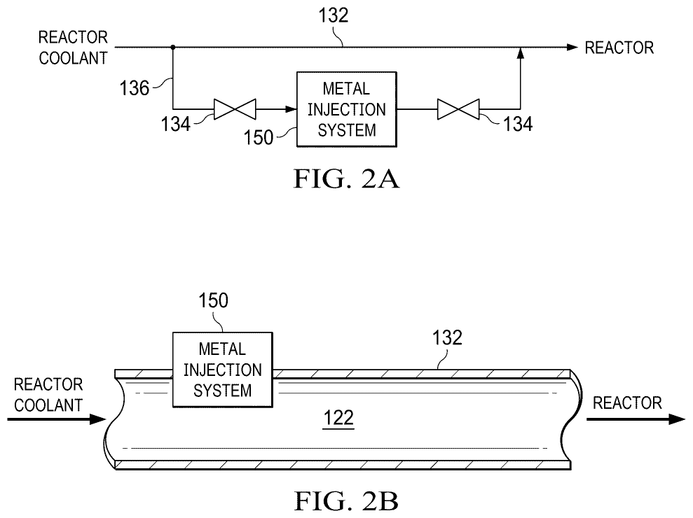

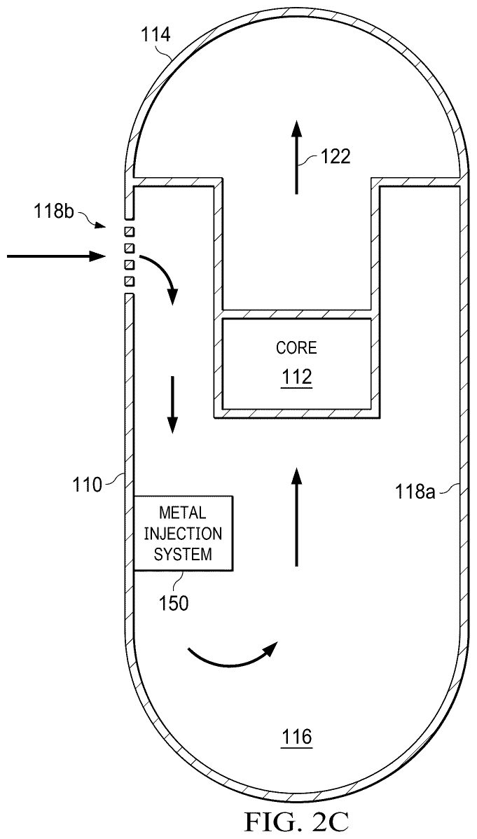

Again, referring to FIG. 1, some example embodiments of the coolant circuit 120 may include a metal injection system 150. As depicted in FIG. 1, the metal injection system 150 is located in a feedwater pipe 132 flowing coolant 122 into the reactor pressure vessel 114. As used herein, the feedwater pipe 132 refers to a pipe in the coolant circuit 120 that is connected to (e.g., contacting) the reactor pressure vessel 110. For example, the feedwater pipe 132 may refer to a pipe in which there is not any intervening nuclear process equipment (e.g., pumps, heat exchangers, condensers, steam generators, pressurizers, or the like) between the pipe and the nuclear reactor 110. However, the example embodiments are not so limited thereto. For example, the metal injection system 150 may be located at any position in the coolant circuit 120 adjacent to the nuclear reactor 110 as described in greater detail below with regard to FIGS. 2A-2C.

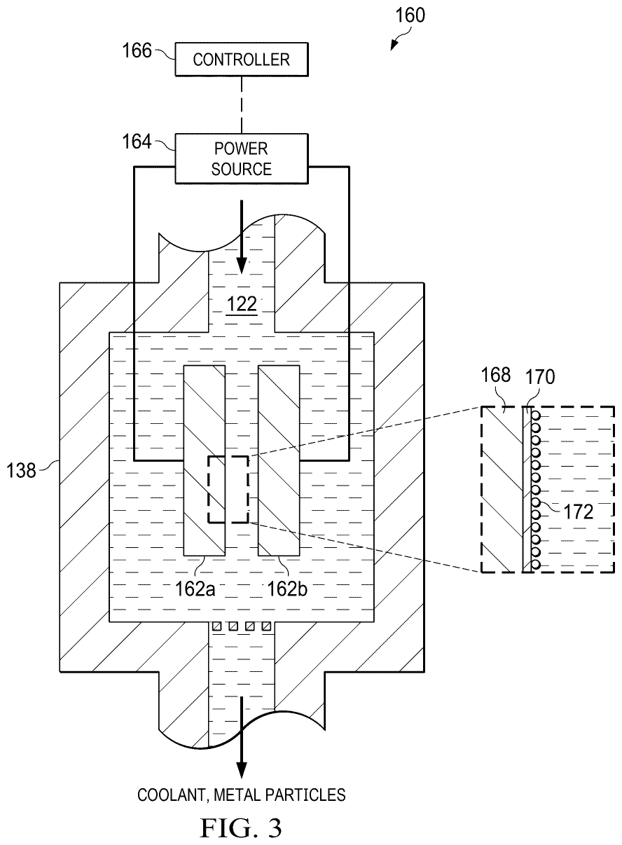

The metal injection system 150 may be at least one of an active metal injection system or a passive metal injection system. As used herein, an active metal injection system means a metal injection system in which the release of metal into the coolant is controlled based on the operation of a control device, based on controlled application of voltage, or any stimulus independent of the coolant. Accordingly, by controlling the rate of release of metal particles into the coolant, the down time or stoppages may be reduced. In some example embodiments, the metal injection system 150 may include the active metal injection system 160 described below with reference to FIGS. 3-5.

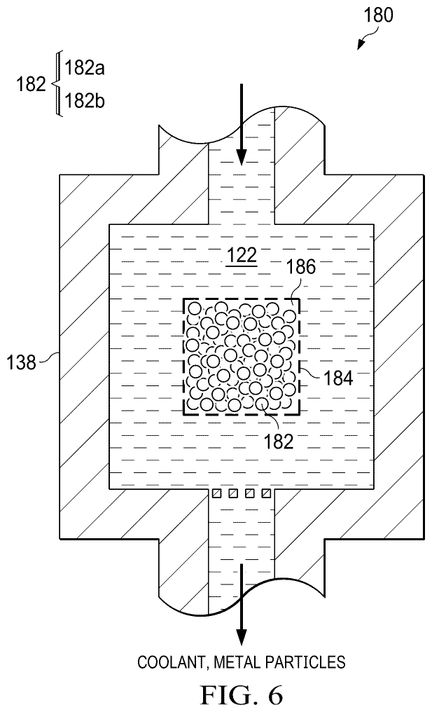

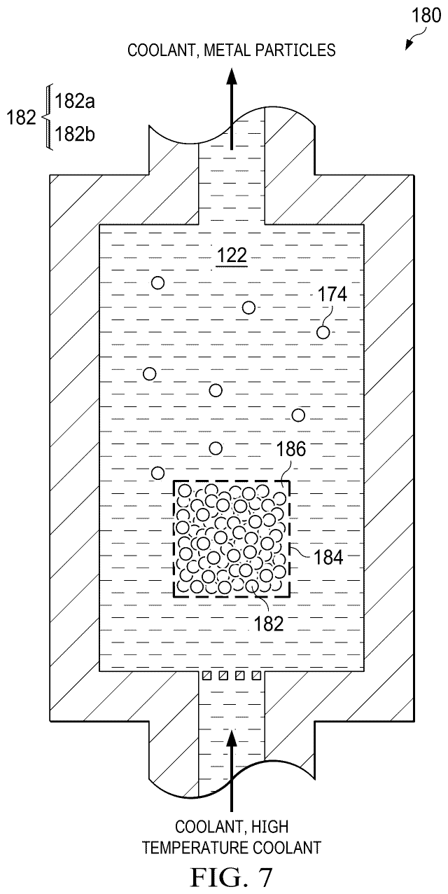

As used herein, a passive metal injection system means a metal injection system in which functions without additional stimulus once the metal injection system is implemented. For example, a passive metal injection system may release metal into the coolant without any control device or manual interaction with the system to control independent of the coolant flowing in contact with the passive metal injection system. Accordingly, by implementing a passive system expenses and labor associated with storing, handling, and/or operating such traditional metal injection systems may be reduced while providing the metal to the coolant such that a likelihood of stress corrosion cracking is reduced. In some example embodiments, the metal injection system 150 may include the passive metal injection system 180 described below with reference to FIGS. 6-7.

Moreover, either of the passive metal injection systems or the passive metal injection systems described herein may provide for a reduced down time or stoppages as well as reduced labor and expenses associated with handling traditional metal injections systems. Additionally, as neither the passive metal injection systems or the active metal injection systems described herein implement a carrier solution, additional conductive materials, that may increase the likelihood of stress corrosion cracking, may not be introduced into the coolant when implementing the metal injection systems. Accordingly, the reliability and durability of the nuclear process equipment may be improved.

FIG. 2A is a schematic layout depicting a location of a metal injection system in a coolant circuit according to some example embodiments.

FIG. 2B is a schematic layout depicting a location of a metal injection system in a coolant circuit according to some example embodiments.

FIG. 2C is a schematic layout depicting a location of a metal injection system in a coolant circuit according to some example embodiments.

For example, FIGS. 2A-2C may depict various locations of a metal injection system 150 in a coolant circuit 120 as shown in FIG. 1.

With reference to FIG. 2A, in some example embodiments, the metal injection system 150 may be located at a branch feedwater line 136 of the feedwater pipe 132 in the coolant circuit 120. As used herein, where the metal injection system 150 is described as at a specific location within the coolant circuit 120, the metal injection system as described is in connected to (e.g., contacting) and in fluidic communication with the described location. As used herein, a branch feedwater line 136 may refer to any pipe that splits off from (e.g., defines a flow separate from) the feedwater pipe 132 and is fluidically connected to the feedwater pipe 132. For example, the metal injection system 150 may be located at a branch feedwater line 136 of the feedwater branch pipe 132 with accompanying flow control valves 134 upstream and downstream of the metal injection system 150 at the branch feedwater line. For example, the metal injection system 150 may be included in a pressure vessel 138 (See FIGS. 3 and 5) and flow control valves 134 may be upstream and downstream of the pressure vessel 138 at the branch feedwater line 136 such that the pressure vessel 138 and the metal injection system 150 may be isolated by controlling the flow control valves 134, for example by closing both flow control valves.

With reference to FIG. 2B, in some example embodiments, the metal injection system 150 may be located at a direct line of the feedwater pipe 132. For example, the metal injection system 150 may be located at least partially in (e.g., may protrude into an interior of) a pipe or pressure vessel at the feedwater pipe 132 as depicted in FIG. 2B. As described above with respect to FIG. 2A, the metal injection system 150 as shown in FIG. 2B may also include flow control valves 134 arranged upstream and downstream of the metal injection system 150 at the feedwater pipe 132 such that the metal injection system 150 may be isolated from the interior of the feedwater pipe 132 by flow control valves 134 (see description of flow control valves 134 above with reference to FIG. 2A), for example, by closing both flow control valves 134. In some example embodiments, when the coolant circuit 120 includes the metal injection system 150 at the feedwater pipe 132, and the feedwater pipe 132 includes flow control valves 134 configured to isolate the metal injection system 150, the feedwater pipe 132 may include one or more branch feedwater lines 136 configured to direct the coolant 122 to bypass the isolated metal injection system 150. In some example embodiments, the metal injection system 150 may not be contained within a pressure vessel (for example, see FIGS. 3-4 or 5-6) and may be at (e.g., attached, fixed, connected) to a side wall of the feedwater pipe 132.

With reference to FIG. 2C, in some example embodiments, the metal injection system 150 may be located within an interior 116 of the reactor pressure vessel 114. The interior 116 of the reactor pressure vessel 114 may be at least partially defined by an inner surface 118a of the reactor pressure vessel 114. In some example embodiments, the metal injection system 150 may located adjacent (e. g, immediately adjacent) to a feedwater pipe inlet 118b of the reactor pressure vessel 114. For example, the metal injection system 150 may be attached to a flange within the reactor pressure vessel 114. In some example embodiments, including the example embodiments shown in FIG. 2C, the metal injection system 150 may be fixed to an inner surface 118a of the reactor pressure vessel 114 (e.g., an inner surface thereof). For example, the metal injection system 150 may at least partially protrude through a sidewall thickness of the reactor pressure vessel 114 into the interior 116.

However, the example embodiments of the location of the metal injection system 150 within the coolant circuit 120 are not limited to the example embodiments described above with regard to FIGS. 2A-2C. For example, the metal injection system 150 may be located at any location along the coolant circuit 120 that is adjacent to the nuclear reactor 110. For example, the metal injection system 150 may be at any location in the coolant circuit 120 that does not have an intervening piece of nuclear process equipment (e.g., pump, heat exchanger, pressure vessel, etc.) between the metal injection system 150 and the nuclear reactor 110.

In some example embodiments, the coolant 122 that flows into or across (e.g., in contact with) the metal injection system 150 may be at process conditions. For example, in some example embodiments, the coolant 122 that flows into or across the metal injection system 150 may be at a temperature and/or pressure equal (e.g., within 10% tolerance) to or greater than the temperature and pressure of the coolant 122 entering the nuclear reactor 110. For example, in some example embodiments the temperature of the coolant 122 in contact with the metal injection system 150 may be between about 220° C. and 340° C. For example, in some example embodiments, the temperature of a coolant 122 in contact with the metal injection system 150 in a boiling water reactor 110 may be between 220° C. and 240° C. For example, in some example embodiments, the temperature of coolant 122 in contact with the metal injection system 150 may be between about 270° C. and 340° C.

FIG. 3 is a schematic layout depicting an active metal injection system in an oxidized state according to some example embodiments.

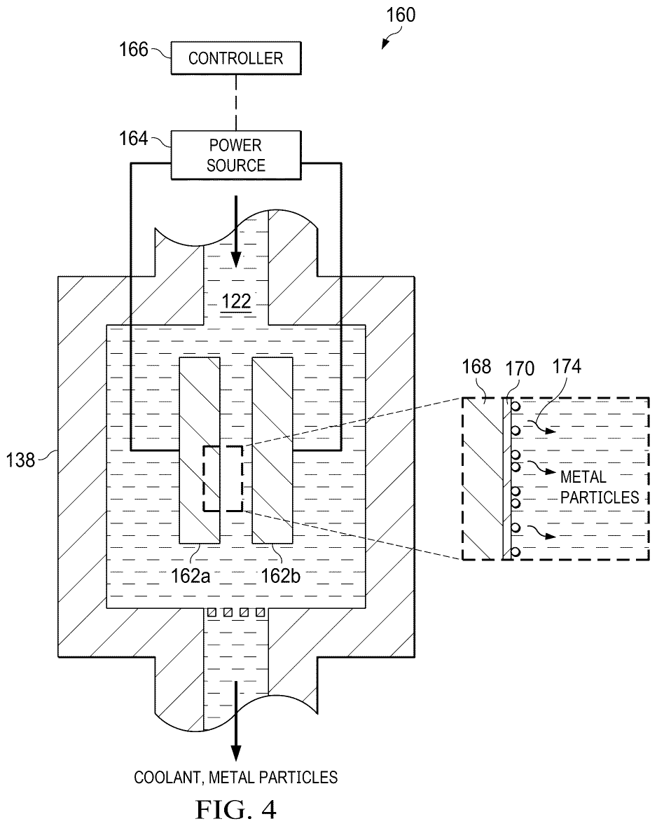

FIG. 4 is a schematic layout depicting an active metal injection system (e.g., the active metal injection system of FIG. 3) in a reduced state according to some example embodiments. For example, the metal injection system 150 as depicted in FIGS. 1-2C may be an active metal injection system 160 as depicted in FIGS. 3-4.

With reference to FIG. 3, in at least one example embodiment, an active metal injection system 160 may include at least two electrodes 162a and 162b, a power source 164, and a controller 166. The active metal injection system 160 may be located at any location in a coolant circuit 120 described above with regard to the metal injection system 150.

In some example embodiments, at least one of the electrodes 162a and/or 162b may include a metal 170 including at least one of platinum, gold, palladium, rhodium, ruthenium, osmium, silver, iridium, titanium, zinc, nickel, iron, or any combination thereof. For example, at least one of the electrodes 162a and/or 162b may be supported by a substrate material 168 including at least one of titanium, steel, ceramics, polymers, or any combination thereof. However, the example embodiments are not so limited thereto. For example, the substrate material 168 may be any such stable and conductive material. In some example embodiments, the at least one of the electrodes may include a substrate material 168 coated with the at least one metal 170. For example, at least one of the electrodes 162a and/or 162b may be coated with the at least one metal 170 such that the at least one metal 170 is exposed to the coolant 122 flowing through the coolant circuit 120. In some example embodiments, for example as depicted in FIG. 3, each of the at least two electrodes 162a and 162b may include the at least one metal 170. However, the example embodiments are not so limited thereto. For example, one or more electrodes 162a may include the at least one metal 170 and one or more of the electrodes 162b may not include any of the metal 170.

A surface area of the at least one metal 170 at the at least one electrode 162a that is exposed to the coolant 122 and/or a surface area of the at least one electrode 162a that is exposed to the coolant 122 may be between about 1 m² and about 200 m² (e.g., about 25 m² to about 175 m², about 50 m² to about 150 m², 75 m² to about 125 m²). For example, a surface area of the at least one metal 170 that is exposed to the coolant 122 may be greater than 40 m². In some example embodiments a distance between two surfaces of the at least two electrodes 162a and 162b, e.g., between two immediately adjacent opposing surfaces of the at least two electrodes 162a and 162b, may be between about 1 mm and about 10 cm. However, the example embodiments are not so limited thereto.

In some example embodiments, a voltage may be applied to the at least two electrodes 162a and 162b (e.g., by the power source 164). For example, one of the at least two electrodes 162a or 162b may serve as a cathode and the other one of the at least two electrodes 162a or 162b may serve as a cathode, and the power source 164 may apply the voltage to the cathode 162a in order to apply the voltage to the at least two electrodes 162a and 162b. In some example embodiments, a controller 166 may be configured to control the application of the voltage to the at least two electrodes 162a and 162b to cycle between a first voltage and a second voltage over a period of time as explained in greater detail with respect to FIG. 5. As depicted in FIG. 3, in an oxidized state, an outer portion of the metal 170 (e.g., an outer portion including an external surface thereof) may be oxidized to form a metal oxide layer 172 loosely-attached metal oxide particles at the metal 170 in the at least two electrodes 162a and 162b. As depicted in FIG. 4, in a reduced state, the loosely-attached metal oxide particles in a metal oxide layer 172 may be reduced from a metal oxide to positively charged metal particles 174 which may detach from the metal 170 based on being reduced and thus may be released from the at least two electrodes 162a and 162b into the coolant 122.

In some example embodiments, the at least two electrodes 162a and 162b may be inserted through a side wall of a feedwater pipe 132, pressure vessel 138, or reactor pressure vessel 114 in the coolant circuit 120 to establish the active metal injection system 160. For example, in some example embodiments the active metal injection system 160 may not include any pressure vessel 138. In some example embodiments the at least two electrodes 162a and 162b may be connected to the power source 164 and the controller 166, where the power source 164 and/or the controller 166 may be external to the coolant circuit 120. However, the example embodiments are not so limited thereto. In some example embodiments, the at least two electrodes 162a and 162b and the controller 166 may be within the coolant circuit 120 (e.g., within a feedwater pipe, a pressure vessel, or the reactor pressure vessel 114 so as to be exposed to coolant 122 therein). In some example embodiments the power source may be external to the coolant circuit 120.

FIG. 5 is a voltage vs time graph depicting a voltage applied to the at least two electrodes and in an active metal injection system according to some example embodiments. For example, FIG. 5 may depict a voltage applied to the at least two electrodes 162a and 162b by the power source 164 and the controller 166 of the active metal injection system 160 as shown in FIGS. 3-4. Additionally, FIG. 5 may depict the surface conditions of the at least two electrodes 162a and 162b in response to such applied voltages.

The controller 166 as described herein may include or be implemented in processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc. In some example embodiments, the processing circuitry may include a computer-readable storage medium (e.g., memory), for example a solid-state drive (SSD) storage device storing a program of instructions, and a processor (e.g., a CPU) configured to execute the program of instructions to cause the controller 166 to control the voltage applied to the at least two electrodes 162a and 162b from the power source 164, for example to cycle the voltage applied thereto as described herein, for example based on executing the program of instructions to generate and transmit a signal to a device (e.g., to the power source 164, which may include a voltage regulator, and/or to a voltage regulator in the controller 166) to control the value (e.g., magnitude) of voltage applied from power source 164 to the at least two electrodes 162a and 162b. For example, at least one of the controller 166 or the power supply 164 may include a voltage regulator, which may be any known voltage regulator and which is configured to receive electrical power from the power source 164 and set, adjust, and/or control a level (e.g., value and/or magnitude) of a voltage that is applied from the voltage regulator to the at least two electrodes 162a and 162b, based on operation of the processing circuitry to control the voltage regulator (e.g., based on a control signal transmitted from the processing circuitry to the voltage regulator). For example, the processing circuitry of the controller 166 may include a processor that executes a program of instructions stored in a computer-readable storage medium of the controller 166 to cause the voltage regulator to control and/or adjust the voltage level of the voltage that is applied from the voltage regulator to the at least two electrodes 162a and 162b (e.g., based on the processing circuitry executing the program of instructions to generate and transmit a control signal to the voltage regulator to cause the voltage regulator to adjust, control, and/or set the applied voltage level, although example embodiments are not limited thereto).

With reference to FIG. 5, in some example embodiments, the controller 166 may cycle the voltage applied to the at least two electrodes 162a and 162b from the power source 164. For example, the voltage may be cycled between a first voltage V1 and a second voltage V2 over a period of time (e.g., based on operation of the controller 166 to control the voltage applied to the at least two electrodes 162a and 162b from the power source 164). In some example embodiments, the cycling may be in a triangle wave pattern (e.g., as shown in FIG. 5). However, the example embodiments are not so limited thereto. For example, in some example embodiments, the applied current may be cycled in a stepwise or sinusoidal pattern.

In some example embodiments, the first voltage V1 may be less than or equal to 0.8 V (e.g., between 0 V and 0.8 V). In some example embodiments, the second voltage V2 may be greater than or equal to 1 V (e.g., between 1 V and 5 V). The rate of voltage change may be between about 1 mV/s and 1 V/s. However, the example embodiments are not so limited thereto. For example, a difference in time between t1 and t2 may be between about 0.1 seconds and about 5,000 seconds (e.g., about 1 second, about 10 seconds, about 100 seconds, about 1,000 seconds, etc.).

As shown in some example embodiments depicted in FIG. 5, based on the first voltage applied to the at least two electrodes 162a and 162b being changed from the first voltage V1 at time t1 to the second voltage V2 at time t2, the coolant 122 (e.g., water) may function as an electrolyte and the metal 170 in the at least one electrode 162a (e.g., at an outer portion of the at least one electrode 162a, including for example an exposed outer surface of the at least one electrode 162a) may be oxidized to form a metal oxide 172 that includes the loosely-attached metal oxide particles at an outer surface of the at least one electrode 162a.

For example, based on the controller 166 causing lower voltages (e.g., V1) to be applied to the at least two electrodes 162a and 162b in the presence of an electrolyte coolant 122, the applied small amounts of the metal 170 may dissolve anodically in the presence of electrolyte coolant 122 (e.g., water) from unstable surface sites at the metal 170 such as kinks and steps. However, based on the controller 166 causing higher voltages (e.g., V2) to be applied to the at least two electrodes 162a and 162b in the presence of the electrolyte coolant 122 (e.g., water), an outer portion of the metal 170 may oxidize to form metal oxide (e.g., a metal oxide film) based on exposure to the coolant (e.g., water), and oxygen may penetrate through the metal oxide into an interior of the metal 170 (e.g., to the un-oxidized metal) and thereby reduce (e.g., break) a number of inter-metal bonds between the metal oxide and the interior, un-oxidized metal to form loosely-attached metal oxide particles that are loosely-attached to the interior un-oxidized metal 170. Due to the bond breakage, the metal may become unsaturated and dissolves anodically to form metal particles 174 that are detached from the metal 170 in response to the controller 166 causing the voltage applied to the at least two electrodes 162a and 162b in the presence of the electrolyte coolant 122 to be reduced from the higher voltage (e.g., the second voltage V2) to the lower voltage (e.g., the first voltage V1). As the voltage applied to the at least two electrodes 162a and 162b decreases from the second voltage V2 to the first voltage V1, a reduction dissolution of Metal-O₂ may occur. In some example embodiments, by cycling the voltage from the first voltage V1 to the second voltage V2, bare metal 170 surfaces may repeatedly appear and the dissolution reaction may be repeated, accelerating the dissolution of the metal 170 into metal particles 174.

For example, in example embodiments where the electrodes 162a and 162b each include a metal 170 that is platinum, the coolant 122 is water, and the voltage applied to the electrodes 162a and 162b is cycled (based on operation of the controller 166) between V1=0.6V and V2≥1.2V, a small amount of Pt may dissolve anodically from unstable surface sites of at least one of the electrodes 162a or 162b electrode, such as kinks and steps. Based on the applied voltage being greater than 1.2V, the Pt metal 170 of at least one electrode exposed to the water coolant 122 may oxidize to form a Pt—O layer that may exceed 1 mm in thickness and oxygen atoms may penetrate from the electrolyte coolant (e.g., water) through the Pt—O layer into the un-oxidized Pt interior of the at least one electrode. During this penetration, a decrease in the coordination number of Pt—Pt bonds in the at least one electrode may occur, and the Pt, which has become coordinatively unsaturated due to bond breakage, may dissolve anodically. Additionally, based on the applied voltage being reduced during the cycling (e.g., change from V2>1.2V to V1=0.6V), a reduction dissolution reaction of Pt—O formed in some areas of the at least one electrode may occur. Under cycling of the applied voltage (e.g., between V1=0.6V and V2=1.2V), Pt—O in the at least one electrode may be reduced, and the bare Pt surface of the at least one electrode may repeatedly appear. Therefore, the dissolution reaction is repeated at the at least one electrode, accelerating the dissolution of Pt to form Pt metal particles 174.

For example, based on the voltage applied to the at least two electrodes 162a and 162b being subsequently cycled from the second voltage V2 at time t2 to the first voltage V1 at time t3, the metal oxide 172 (e.g., the loosely-attached metal oxide particles) may be reduced by the coolant 122 from the metal oxide 172 to the metal to form metal particles 174. The metal particles 174 may detach from the at least one electrode 162a based on being reduced from the metal oxide particles and thus may be released from one or more surfaces of the at least one electrode 162a due to the voltage cycling and the metal particles 174 may be entrained in the coolant 122 flowing through the coolant circuit 120 such that the metal particles 174 are carried into nuclear process equipment downstream from the active metal injection system 160, for example, the nuclear reactor 110. For example, in some example embodiments, the metal particles 174 may coat the nuclear process equipment and/or surfaces through electroplating or electroless plating to recombine oxidants and thereby reduce the likelihood of stress corrosion cracking.

As described above, the active metal injection system 160 may be located within a pressure vessel in the feedwater pipe 132 or a branch feedwater line 136. Additionally, the active metal injection system 160 may be included in the feedwater pipe 132 itself. For example, the at least two electrodes 162a and 162b may protrude through the feedwater pipe 132 side wall exposing the surfaces of the at least two electrodes 162a and 162b to the coolant 122 flowing through the coolant circuit 120. In some example embodiments, the controller 166 may be located within the coolant circuit 120. For example, in some example embodiments, the at least two electrodes 162a and 162b and the controller 166 may be within the reactor pressure vessel 114. In some example embodiments, the at least two electrodes 162a and 162b may not extend through a side wall of the reactor pressure vessel 114. For example, in some example embodiments, the at least two electrodes 162a and 162b and the controller 166 may be secured to a flange within the reactor pressure vessel 114. However, the example embodiments are not so limited thereto.

FIG. 6 is a schematic layout depicting a passive metal injection system according to some example embodiments.

With reference to FIG. 6, in some example embodiments, a passive metal injection system 180 may include a dissolvable doped porous material 182 and a permeable containment structure 184. The passive metal injection system 180 may be located at any location in a coolant circuit 120 described above with regard to the metal injection system 150. For example, in some example embodiments the metal injection system 150 described with reference to FIGS. 1 and 2A-2C may be a passive metal injection system 180 as depicted in FIG. 6.

In some example embodiments, dissolvable doped porous material 182 may include a dissolvable porous material 182a and a metal 182b doped in the dissolvable porous material 182a. In some example embodiments, the dissolvable porous material 182a may include at least one of a zeolite, a mesoporous silica material, or any combination thereof. However, the example embodiments are not so limited thereto. For example, the dissolvable porous material may be a dissolvable material (e.g., a material configured to dissolve in response to prolonged exposure to the coolant 122) with a surface area greater than 100 m²/g. In some example embodiments, the dissolvable porous material 182a is in the form of a plurality of pellets.

In some example embodiments the metal 182b may include at least one of platinum, gold, palladium, rhodium, ruthenium, osmium, silver, iridium, titanium, zinc, nickel, iron, or any combination thereof.

In some example embodiments, the permeable containment structure 184 may at least partially define an enclosure 186 configured to contain the dissolvable doped porous material 182. For example, the permeable containment structure 184 may at least partially define a boundary defining the enclosure 186 in which the dissolvable doped porous material 182 may be located and from which may be restricted from leaving in an undissolved state. For example, the permeable containment structure 184 may have openings smaller than the average particle size of the undissolved doped porous material 182. In some example embodiments, the permeable containment structure 184 may be permeable to the coolant 122 and thereby allow the coolant 122 in the coolant circuit 120 to flow through the permeable containment structure 184 into the enclosure 186 and contact the dissolvable doped porous material 182.

In some example embodiments, the permeable containment structure 184 includes a stable material that does not degrade (e.g., dissolve) with exposure to the coolant 122. For example, the stable material may be a metal such as stainless steel, a structurally stable plastic, or the like. In some example embodiments, the permeable containment structure 184 may include the dissolvable porous material 182a. For example, in some example embodiments, the permeable containment structure 184 may include a stable material as a substrate and the stable material may be coated with the dissolvable porous material 182a to form the permeable containment structure 184.

In some example embodiments, the permeable containment structure 184 may be filled with the dissolvable doped porous material 182 prior to inserting the permeable containment structure 184 being inserted into coolant circuit 120. In some example embodiments the permeable containment structure 184 may be inserted into an opening in the coolant circuit 120. However, the example embodiments are not so limited thereto and in some example embodiments the permeable containment structure 184 may be attached to the coolant circuit 120 (e.g., feedwater pipes, pressure vessels) such that the permeable containment structure 184 is a fixed structure withing the coolant circuit 120.

FIG. 7 is a schematic layout depicting a passive metal injection system implementing a porous carrier according to some example embodiments. For example, FIG. 7 may depict the operation of a passive metal injection system 180 as depicted in FIG. 6.

With reference to FIG. 7, in some example embodiments, as the dissolvable doped porous material 182 is exposed to flowing coolant 122 in the permeable containment structure 184, the dissolvable porous material 182a is dissolved releasing the doped metal 182b into the coolant 122 flow as metal particles 174 which comprise the doped metal. The doped metal 182b entrained in the coolant 122 as metal particles 174 may flow downstream from the permeable containment structure 184 to other nuclear power plant process equipment, for example, the nuclear reactor 110.

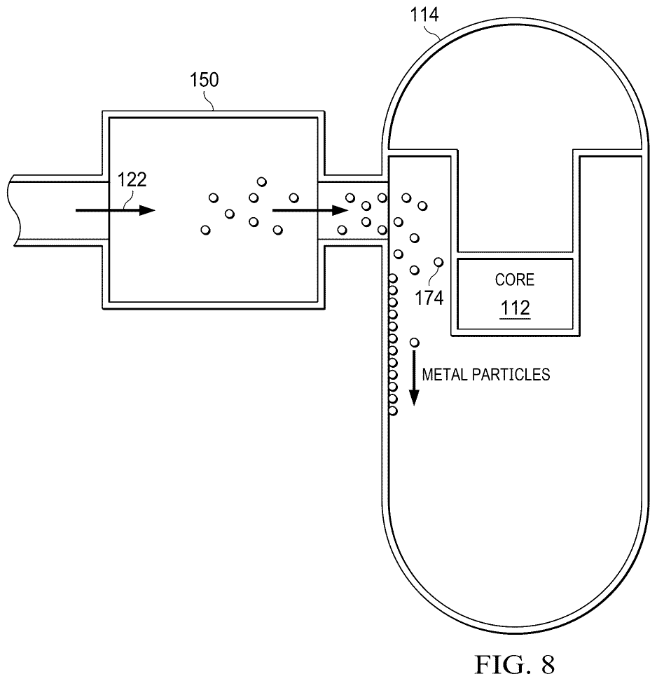

FIG. 8 is a schematic layout depicting the coating of nuclear process equipment according to some example embodiments. For example, FIG. 8 may depict a nuclear reactor 110 being coated by metal particles 174 produced by a metal injection system 150, which may be at least one of an active metal injection system 160 (e.g., as illustrated and described with reference to FIGS. 3-5) or a passive metal injection system 180 (e.g., as illustrated and described with reference to FIGS. 6-7).

Referring to FIG. 8, in some example embodiments, downstream from metal injection system 150, for example at least one of the active metal injection system 160 or the passive metal injection system 180, metal particles 174 released by the metal injection system 150 may be entrained in the coolant 122. As shown with reference to FIG. 8, in some example embodiments, such metal particles 174 may be carried by the coolant 122 into the nuclear reactor 110 where the metal particles 174 may adhere to one or more nuclear process equipment surfaces, for example one or more surfaces of the reactor pressure vessel 114 that are exposed to the coolant 122. Therefore, the metal particles 174 may coat such one or more surfaces through electroplating or electroless plating to recombine hydrogen and oxidants and thereby reduce the likelihood of the reactor pressure vessel 114 cracking due to stress corrosion cracking. For example, the metal particles 174 may coat any nuclear process equipment surface for example, inner surface 118a of the reactor pressure vessel 114, plenum walls, downcomer walls, outer surfaces control rods, exposed sensors, flanges, inner surfaces of pipes, inner surfaces of coolant channels, and/or the like. However, the example embodiments are not so limited to the above listed surfaces and may coat any exposed surface within the nuclear reactor 110. By coating such nuclear process equipment surfaces with metal particles 174, hydrogen and oxidants in the coolant environment (e.g., directly exposed to the coolant 122) may be recombined and the likelihood of cracking due to stress corrosion cracking may be reduced, thereby improving the reliability and durability of the nuclear process equipment.

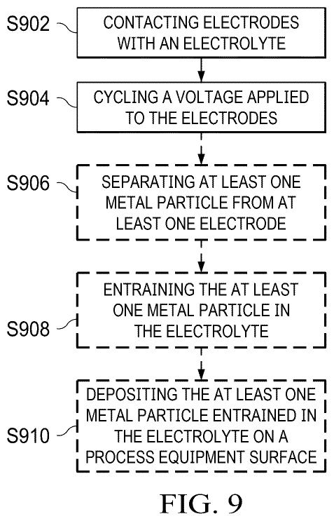

FIG. 9 is a flow chart depicting a method of operating an active metal injection system according to some example embodiments.

Referring to FIG. 9, in some example embodiments, a method of operating an active metal injection system according to some example embodiments may include an operation S902 including contacting electrodes with an electrolyte and an operation S904 including cycling a voltage applied to the electrodes. The method as depicted in FIG. 9 may be implemented with the active metal injection system 160 as described above. Operations S906 through S910 as depicted are optional steps that may be included in such a method.

In operation S902, the method may include contacting electrodes of a metal injection system with an electrolyte. In some example embodiments, the electrolyte may be a coolant 122 in a coolant circuit 120 as described above with reference to at least FIGS. 1, 2A-2C, 3, 4, 5, 6, 7, and 8. For example, the electrolyte may be water operating as a coolant 122 in a coolant circuit 120. The electrodes contacted with the electrolyte (e.g., coolant 122) may be the same as the at least two electrodes 162a and 162b described above regarding the active metal injection system 160. In some example embodiments, contacting the electrodes with the electrolyte may include flowing the electrolyte across (e.g., in contact with) an exposed outer surface of the electrode. However, example embodiments are not so limited thereto.

In operation S904, the method may include cycling a voltage applied to the electrodes between a first voltage and a second voltage over a period of time concurrently with contacting the electrodes with the electrolyte, for example based on a controller controlling the application of voltage to the electrodes by a power supply. In some example embodiments, a controller, which may be the controller 166 described above with regard to the active metal injection system 160, may control a voltage applied to the electrodes from a power source, for example the power source 164 described above with regard to the active metal injection system 160. Such a controller and power source may be the controller 166 and the power source 164 described above with reference to FIGS. 3-5. Accordingly, the controller and power source may function as described with reference to FIGS. 3-5. Therefore, description of the characteristics of the cycled voltage are not repeated here for brevity and clarity.

In operation S906, the method may include separating at least one metal particle from at least one electrode of the electrodes contacting the electrolyte, based on cycling the voltage applied to the electrodes between a first voltage and a second voltage over a period of time. In some example embodiments, one of the electrodes may serve as a cathode and the other one of the at least two electrodes may serve as an anode. In some example embodiments, as described above with reference to FIG. 5, based on cycling the voltage applied to the electrodes, in an oxidized state an outer portion of the metal (e.g., an outer portion including an external surface thereof) may be oxidized to form metal oxide layer of metal oxide particles on the metal. Additionally, in a reduced state, the oxide particles in a metal oxide layer 172 may be reduced from a metal oxide to positively charged metal particles which may detach from the metal based on being reduced and thus may be released from the at least two electrode into the coolant.

In operation S908, the method may include entraining the at least one metal particle in the electrolyte. In some example embodiments, as described above with reference to FIGS. 5 and 8, at least one metal particle may be separated from the at least one electrode, the at least one metal particle may be entrained in the electrolyte and carried downstream from the at least one electrode by the electrolyte flow.

In operation S910, the method may include depositing the at least one metal particle entrained in the electrolyte on a nuclear process equipment surface. In some example embodiments, as described above with reference to FIG. 8, the metal particles 174 may be carried by coolant 122 into nuclear process equipment, such as a nuclear reactor, where the at least one metal particle may adhere to a surface of the reactor pressure vessel that is exposed to the coolant. For example, the metal particles 174 may coat any nuclear process equipment surface for example, inner surface of the reactor pressure vessel, plenum walls, downcomer walls, outer surfaces control rods, exposed sensors, flanges, inner surfaces of pipes, inner surfaces of coolant channels and the like. However, the example embodiments are not so limited to the surfaces listed above and may include any surface exposed to the electrolyte within the interior of the nuclear reactor. The metal particles 174 may coat such surfaces through electroplating or electroless plating to recombine hydrogen and oxidants, reducing the likelihood of the reactor pressure vessel 114 cracking due to stress corrosion cracking, thereby improving the reliability and durability of the nuclear process equipment.

Moreover, by operating an active metal injection system according to the methods described herein, down time and/or stoppages as well as expenses and/or labor associated with storing and handling such traditional metal injection systems may be reduced while providing the metal to the coolant such that a likelihood of stress corrosion cracking is reduced. Additionally, as operating an active metal injection system as described herein may not use a carrier solution to introduce the metal into the coolant, additional conductive materials, that may increase the likelihood of stress corrosion cracking, may not be introduced into the coolant when implementing the metal injection systems and the reliability and durability of the nuclear process equipment may be improved.

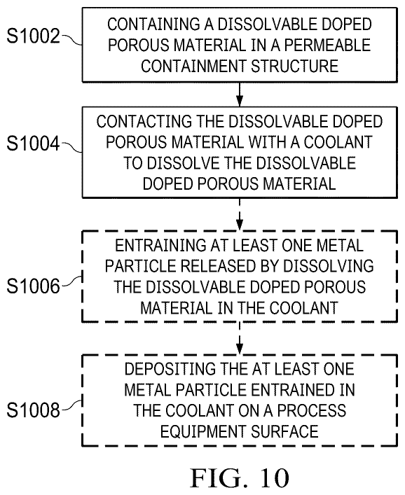

FIG. 10 is a flow chart depicting a method of operating a passive metal injection system according to some example embodiments.

Referring to FIG. 10, in some example embodiments, a method of operating a passive metal injection system may include an operation S1002 including containing a dissolvable doped porous material in a permeable containment structure and operation S1004 including contacting the dissolvable doped porous material with a coolant to dissolve the dissolvable doped porous material. The method as depicted in FIG. 10 may be implemented with the passive metal injection system 180 as described above. Operations S1006 through S1008 as depicted are optional steps that may be included in such a method.

In operation S1002, the method may include containing a dissolvable doped porous material in a permeable containment structure, in some example embodiments, the dissolvable doped porous material may be a dissolvable doped porous material 182 described above. In some example embodiments, the permeable containment structure may be the permeable containment structure 184 described above. In some example embodiments, the containing may include placing dissolvable doped porous material 182 in the form of a plurality of pellets into the permeable containment structure 184 defined by a basket including a stable material, such as stainless steel. In some example embodiments, the containing includes inserting the dissolvable doped porous material into the permeable containment structure.

In operation S1004, the method may include contacting the dissolvable doped porous material with a coolant fluid to dissolve the dissolvable doped porous material. In some example embodiments, the operation may include inserting the permeable containment structure in the form of a basket containing the dissolvable doped porous material in a pressure vessel, feedwater pipe, and/or reactor pressure vessel in the coolant circuit 120 as described above. Additionally, in some example embodiments, operation S1004 may include flowing the coolant through the coolant circuit such that it flows through the permeable containment structure to contact the dissolvable doped porous material.

In operation S1006, the method may include entraining at least one metal particle released by dissolving the dissolvable doped porous material in the coolant. In some example embodiments, as described above with reference to FIGS. 6 and 7, at least one metal particle may be released when the dissolvable porous material dissolves releasing the metal particles doped within the dissolvable doped porous material and the at least one metal particle may be entrained in the coolant and carried downstream from the permeable containment structure by the coolant flow.

In operation S1008, the method may include depositing the at least one metal particle entrained in the coolant at a nuclear process equipment surface. In some example embodiments, as described above with reference to FIG. 7, the metal particles may be carried into nuclear process equipment, such as a nuclear reactor, where the particles may adhere to a surface of the reactor pressure vessel that is exposed to the coolant. For example, the metal particles may coat any nuclear process equipment surface for example, inner surface of the reactor pressure vessel, plenum walls, downcomer walls, outer surfaces control rods, exposed sensors, flanges, inner surfaces of pipes, inner surfaces of coolant channels and the like. However, the example embodiments are not so limited to the surfaces listed above and may include any surface exposed to the electrolyte within the interior of the nuclear reactor. Therefore, the metal particles may coat such surfaces through electroplating or electroless plating to recombine hydrogen and oxidants and thereby reduce the likelihood of the reactor pressure vessel cracking due to stress corrosion cracking, thereby improving the reliability and durability of the nuclear process equipment.

Moreover, by operating a passive metal injection system according to the methods described herein, down time and/or stoppages as well as expenses and/or labor associated with storing and handling such traditional metal injection systems may be reduced while providing the metal to the coolant such that a likelihood of stress corrosion cracking is reduced. Additionally, as operating a passive metal injection system as described herein does not implement a carrier solution, additional conductive materials, that may increase the likelihood of stress corrosion cracking, may not be introduced into the coolant when implementing the metal injection systems and the reliability and durability of the nuclear process equipment may be improved.

Some Example Embodiments of the inventive concepts are as follows below:
Example Embodiment 1: A metal injection system (180) configured to release metal particles (174) into a coolant (122) configured to be an electrolyte to enable the electrolyte to carry the metal particles (174) through at least a portion of nuclear process equipment (110) to further enable deposition of the metal particles at a nuclear process equipment surface (118a) that is exposed to the electrolyte, the metal injection system comprising:
   at least two electrodes (162a and 162b), at least one electrode (162a) of the at least two electrodes (162a and 162b) including the metal (170), the at least one electrode (162a) configured to be exposed in flow communication with at least a portion of an electrolyte flow pathway (120) that is at least partially defined by the nuclear process equipment surface (118a) of the nuclear process equipment (110) and is configured to circulate the electrolyte (122) to contact the nuclear process equipment surface (118a) of the nuclear process equipment (110), such that the at least one electrode (162a) is configured to be contacted by at least a portion of the electrolyte (122) flowing through the electrolyte flow pathway (120) to further flow in fluid communication with the nuclear process equipment surface (118a);
   a power source (164) connected to each electrode of the at least two electrodes (162a and 162b); and
   a controller (166) configured to control a voltage of electrical power applied from the power source (164) to the at least two electrodes (162a and 162b), the controller (166) is configured to cycle the voltage between a first voltage (V1) and a second voltage (V2) over a period of time to induce separation of at least one metal particle (174) from the at least one electrode (162a) into the electrolyte (122) contacting the at least one electrode (162a), the second voltage (V2) being greater than the first voltage (V1), the cycling including
      increasing the applied voltage from the first voltage (V1) to the second voltage (V2) to cause at least a portion of the metal (170) of the at least one electrode (162a) to oxidize to form a metal oxide (172), and
      decreasing the applied voltage from the second voltage (V2) to the first voltage (V1) subsequently to increasing the applied voltage from the first voltage (V1) to the second voltage (V2) and concurrently with the electrolyte (122) contacting the at least one electrode (162a) to cause at least a portion of the metal oxide (172) to reduce to metal and to separate from the at least one electrode into the electrolyte (122) as the at least one metal particle (174).
Example Embodiment 2: The metal injection system (180) of Example Embodiment 1, wherein
   the second voltage (V2) is in a range of greater than or equal to 1.0 V to less than or equal to 5 V, and
   The first voltage (V1) is less than or equal to 0.8 V.
Example Embodiment 3: The metal injection system (180) of any of Example Embodiments 1 or 2, wherein the controller (166) is configured to cycle the voltage from the power source (164) to the at least two electrodes (162a and 162b) in a triangle wave pattern.
Example Embodiment 4: The metal injection system (180) of any of Example Embodiments 1 to 3, wherein the controller (166) is configured to cycle the voltage between the first voltage (V1) and the second voltage (V2) at a rate of voltage change in a range of 1 mV/s to 1 V/s.
Example Embodiment 5: The metal injection system (180) of any of Example Embodiments 1 to 4, wherein the metal (170) includes at least one of platinum, gold, palladium, rhodium, ruthenium, osmium, silver, iridium, titanium, zinc, nickel, iron, or any combination thereof.
Example Embodiment 6: The metal injection system (180) of any of Example Embodiments 1 to 5, wherein the metal (170) includes platinum.
Example Embodiment 7: The metal injection system (180) according to any of Example Embodiments 1 to 6, wherein the at least two electrodes (162a and 162b) have a combined surface area that is between 1 m² and 200 m².
Example Embodiment 8: The metal injection system (180) according to any of Example Embodiments 1 to 7, wherein a distance between opposing immediately-adjacent surfaces of the at least two electrodes (162a and 162b) is between 1 mm and 10 cm.
Example Embodiment 9: A nuclear power plant (100), comprising:
   a nuclear reactor (110), the nuclear reactor (110) including nuclear reactor process equipment, the nuclear reactor process equipment including at least one of a reactor pressure vessel (114) or a nuclear reactor core (112) within the reactor pressure vessel (114), the nuclear reactor process equipment including a nuclear reactor process equipment surface (118a) at least partially defining an electrolyte flow pathway (120) extending at least partially through the nuclear reactor (110), the nuclear reactor process equipment configured to circulate a coolant (122) configured to be an electrolyte through the electrolyte flow pathway (120) to contact the nuclear reactor process equipment surface (118a); and
   the metal injection system (180) of any of Example Embodiments 1 to 8, wherein the at least one electrode (162a) of the metal injection system (180) is exposed to at least a portion of the electrolyte flow pathway (120) such that the nuclear power plant (100) is configured to circulate at least a portion of the electrolyte (122) to flow in contact with the at least one electrode (162a), the electrolyte flow pathway (120) includes a coolant circuit (120) configured to circulate the coolant (122) through the nuclear reactor (110),
   wherein the controller (166) of the metal injection system (180) is configured to cycle the voltage between the first voltage (V1) and the second voltage (V2) over the period of time, concurrently with the electrolyte (122) circulating through the coolant circuit (120), to induce separation of the at least one metal particle (174) from the at least one electrode (162a) into the electrolyte (122) contacting the at least one electrode (162a) and to further cause the at least one metal particle (174) to deposit at at least one nuclear reactor process equipment surface (118a) based on the electrolyte (122) carrying the at least one metal particle (174) through at least a portion of the coolant circuit (120).
Example Embodiment 10: The nuclear power plant (100) according to Example Embodiment 9, wherein the at least two electrodes (162a and 162b) are within the reactor pressure vessel (114).
Example Embodiment 11: The nuclear power plant (100) according to Example Embodiment 10, wherein the controller (166) is within the reactor pressure vessel (114).
Example Embodiment 12: The nuclear power plant (100) according to any of Example Embodiments 9 to 11, wherein
   the coolant (122) is water, and
   the nuclear power plant (100) is configured to circulate the water (122) through the coolant circuit (120) such that a temperature of water (122) in contact with the at least one electrode (162a) is equal to a temperature of water (122) entering the reactor pressure vessel (114).
Example Embodiment 13: The nuclear power plant (100) according to any of Example Embodiments 9 to 12, wherein the nuclear power plant (100) includes at least two flow control valves (134) are configured to be operated to isolate the at least one electrode (162a) from at least a portion of the electrolyte flow pathway (120) and the nuclear reactor process equipment (110).
Example Embodiment 14: The nuclear power plant (100) according to any of Example Embodiments 9 to 13, wherein
   the coolant circuit (120) includes a feedwater pipe (132) configured to direct coolant (122) into the reactor pressure vessel (110), and
   the at least one electrode (162) is within the feedwater pipe (132).
Example Embodiment 15: The nuclear power plant (100) according to any of Example Embodiments 9 to 14, wherein the nuclear reactor (110) is a boiling water reactor.
Example Embodiment 16: The nuclear power plant (100) according to any of Example Embodiments 9 to 14, wherein the nuclear reactor (110) is a pressurized water reactor.
Example Embodiment 17: The nuclear power plant (100) according to any of Example Embodiments 9 to 16, wherein the water (122) in contact with the at least one electrode (162a) is at a temperature between 220° C. and 340° C.
Example Embodiment 18: A method of releasing metal particles (174) into a coolant (122) configured to be an electrolyte (122) such that the coolant (122) is configured to carry the metal particles (174) through at least a portion of nuclear process equipment (110) to further enable deposition of the metal particles (174) at at least one at least one nuclear process equipment surface (118a) of the nuclear process equipment (110) that is exposed to the electrolyte (122), the method of releasing the metal particles comprising:
   contacting at least two electrodes (162a and 162b) with the electrolyte (122) within an electrolyte flow pathway (120) that is at least partially defined by the at least one nuclear process equipment surface (118a) of the nuclear process equipment (110), at least one electrode (162a) of the at least two electrodes (162a and 162b) including the metal (170);
   circulating the electrolyte (122) through the electrolyte flow pathway (120) such that the at least two electrodes (162a and 162b) are contacted by the electrolyte (122) flowing through the electrolyte flow pathway (120) and the electrolyte (122) flowing through the electrolyte flow pathway (120) are in fluid communication with the at least one nuclear process equipment surface (118a);
   applying a voltage of electrical power to the at least two electrodes (162a and a 162b) from a power source (164) connected to each electrode of the at least two electrodes (162a and 162b); and
   controlling the voltage of electrical power applied from the power source (164) to the at least two electrodes (162a and 162b) such that the voltage cycles between a first voltage (V1) and a second voltage (V2) over a period of time to induce separation of at least one metal particle (174) from the at least one electrode (162a) into the electrolyte (122) contacting the at least one electrode (162a), the second voltage (V2) being greater than the first voltage (V1), the cycling including,
   increasing the applied voltage from the first voltage (V1) to the second voltage (V2) to cause at least a portion of the metal (170) of the at least one electrode (162a) to oxidize to form a metal oxide (172), and
   decreasing the applied voltage from the second voltage (V2) to the first voltage (V1) subsequently to increasing the applied voltage from the first voltage (V1) to the second voltage (V2) and concurrently with the electrolyte (122) contacting the at least one electrode (162a) to cause at least a portion of the metal oxide (172) to reduce to metal and to separate from the at least one electrode (162a) into the electrolyte (122) as the at least one metal particle (174).
Example Embodiment 19: The method of Example Embodiment 18, wherein
   the second voltage (V2) is in a range of greater than or equal to 1.0 V to less than or equal to 5 V, and
   the first voltage (V1) is less than or equal to 0.8 V.
Example Embodiment 20: The method of any of Example Embodiments 18 or 19, wherein the cycling includes cycling the voltage in a triangle wave pattern.
Example Embodiment 21: The method of any of Example Embodiments 18 to 20, wherein controlling includes cycling the voltage between the first voltage (V1) and the second voltage (V2) at a rate of voltage change in a range of 1 mV/s to 1 V/s.
Example Embodiment 22: The method of any of Example Embodiments 18 to 21, wherein the metal (170) includes at least one of platinum, gold, palladium, rhodium, ruthenium, osmium, silver, iridium, titanium, zinc, nickel, iron, or any combination thereof.
Example Embodiment 23: The method of any of Example Embodiments 18 to 22, wherein the metal (170) includes platinum.
Example Embodiment 24: The method of any of Example Embodiments 18 to 23, wherein the circulating and the controlling are performed concurrently to induce separation of the at least one metal particle (174) from the at least one electrode (162a) into the electrolyte (122) contacting the at least one electrode (162a) and to further cause the at least one metal particle (174) to deposit at the at least one nuclear process equipment surface (118a) based on the electrolyte (122) carrying the at least one metal particle (174) through at least a portion of the electrolyte flow pathway (120).
Example Embodiment 25: The method of Example Embodiment 24, wherein
   the nuclear process equipment includes a nuclear reactor (110), the nuclear reactor (110) including at least one of a reactor pressure vessel (114) or a nuclear reactor core (112) within the reactor pressure vessel (114),
   the electrolyte flow pathway (120) includes a coolant circuit (120) that circulates a coolant (122) through the nuclear reactor (110),
   the electrolyte (122) includes the coolant (122) within the coolant circuit (120),
   the at least one nuclear process equipment surface (118a) includes a nuclear reactor surface of the nuclear reactor (110 that is exposed to the coolant (122) based on circulation of the coolant (122) through the nuclear reactor (110), and
   the controller (166) cycles the voltage between the first voltage (V1) and the second voltage (V2) over the period of time, concurrently with the coolant (122) circulating through the coolant circuit (120), inducing separation of the at least one metal particle (174) from the at least one electrode (162) into the coolant (122) contacting the at least two electrodes (162a and 162b) and further cause the at least one metal particle (174) to deposit at the nuclear reactor surface (118a) based on the coolant (122) carrying the at least one metal particle (174) through at least a portion of the nuclear reactor (110).
Example Embodiment 26: The method according to Example Embodiment 25, wherein the at least two electrodes (162a and 162b) are within the reactor pressure vessel (114).
Example Embodiment 27: The method according to any of Example Embodiments 25 or 26, wherein the controller (166) is within the reactor pressure vessel (114).
Example Embodiment 28: The method according to any of Example Embodiments 25 to 27, wherein the nuclear reactor (110) is a boiling water reactor.
Example Embodiment 29: The method according to any of Example Embodiments 25 to 27, wherein the nuclear reactor (110) is a pressurized water reactor.
Example Embodiment 30: The method according to any of Example Embodiments 25 to 29, wherein
   the coolant (122) is water, and
   the water (122) in contact with the at least two electrodes (162a and 162b) is at a temperature between 220° C. and 340° C.
Example Embodiment 31: The method according to any of Example Embodiments 25 to 30, wherein
   the coolant circuit (120) includes a feedwater pipe (132) configured to direct coolant (122) into the reactor pressure vessel (114), and
   the at least two electrodes (162a and 162b) are within the feedwater pipe (132).
Example Embodiment 32: The method according to any of Example Embodiments 18 to 31, wherein the at least two electrodes (162a and 162b) have a combined surface area that is between 1 m² and 200 m².
Example Embodiment 33: The method according to any of Example Embodiments 18 to 32, wherein a distance between opposing immediately-adjacent surfaces of the at least two electrodes (162a and 162b) is between 1 mm and 10 cm.
Example Embodiment 34: A method for assembling a metal injection system (180), the method comprising:
   obtaining a metal injection system (180) configured to release at least one metal particle (174) into a coolant (122) configured to be an electrolyte (122) such that the coolant (122) is configured to carry the at least one metal particle (174) through at least a portion of nuclear process equipment (110) to further enable deposition of the at least one metal particle (174) at at least one nuclear process equipment surface (118a) of the nuclear process equipment (110) that is exposed to the electrolyte (122) for use in a nuclear power plant (100); and
   inserting the metal injection system into a coolant circuit for the nuclear power plant (100),
   the metal injection system (180) including,
      at least two electrodes (162a and 162b), at least one electrode (162a) of the at least two electrodes (162a and 162b) including the metal (170), the at least one electrode (162a) configured to be exposed in flow communication with at least a portion of an electrolyte flow pathway (120) that is at least partially defined by the at least one nuclear process equipment surface (118a) of the nuclear process equipment (110) and is configured to circulate the electrolyte (122) to contact the at least one nuclear process equipment surface (118a) of the nuclear process equipment (110), such that the at least one electrode (162a) is configured to be contacted by at least a portion of the electrolyte (122) flowing through the electrolyte flow pathway (122) to further flow in fluid communication with the at least one nuclear process equipment surface (118a),
      a power source (164) connected to each electrode (162a) of the at least two electrodes (162a and 162b); and
   a controller (166) configured to control a voltage of electrical power applied from the power source (164) to the at least two electrodes (162a and 162b), the controller (166) is configured to cycle the voltage between a first voltage (V1) and a second voltage (V2) over a period of time to induce separation of at least one metal particle (174) from the at least one electrode (162a) into the electrolyte (122) contacting the at least one electrode (162a), the second voltage (V2) being greater than the first voltage (V1), the cycling including
      increasing the applied voltage from the first voltage (V1) to the second voltage (V2) to cause at least a portion of the metal (170) of the at least one electrode (162a) to oxidize to form a metal oxide (174), and
      decreasing the applied voltage from the second voltage (V2) to the first voltage (V2) subsequently to increasing the applied voltage from the first voltage (V1) to the second voltage (V2) and concurrently with the electrolyte (122) contacting the at least one electrode (162a) to cause at least a portion of the metal oxide (172) to reduce to metal and to separate from the at least one electrode (162a) into the electrolyte (122) as the at least one metal particle (174).

While a number of example embodiments have been disclosed herein, it should be understood that other variations may be possible. Such variations are not to be regarded as a departure from the spirit and scope of the present inventive concepts, and all such modifications as would be obvious to one skilled in the art are intended to be included within the scope of the following claims. In addition, while processes have been disclosed herein, it should be understood that the described elements of the processes may be implemented in different orders, using different selections of elements, some combination thereof, etc. For example, some example embodiments of the processes of the inventive concepts may be implemented using fewer elements than that of the illustrated and described processes, and some example embodiments of the processes of the inventive concepts may be implemented using more elements than that of the illustrated and described processes.

What is claimed:

1. A metal injection system configured to release metal particles into a coolant configured to be an electrolyte to enable the electrolyte to carry at least one metal particle through at least a portion of nuclear process equipment to further enable deposition of the at least one metal particle at a nuclear process equipment surface that is exposed to the electrolyte, the metal injection system comprising:
at least two electrodes, at least one electrode of the at least two electrodes including the metal, the at least one electrode configured to be exposed in flow communication with at least a portion of an electrolyte flow pathway that is at least partially defined by the nuclear process equipment surface of the nuclear process equipment and is configured to circulate the electrolyte to contact the nuclear process equipment surface of the nuclear process equipment, such that the at least one electrode is configured to be contacted by at least a portion of the electrolyte flowing through the electrolyte flow pathway to further flow in fluid communication with the nuclear process equipment surface;
a power source connected to each electrode of the at least two electrodes; and
a controller configured to control a voltage of electrical power applied from the power source to the at least two electrodes, the controller is configured to cycle the voltage between a first voltage and a second voltage over a period of time to induce separation of at least one metal particle from the at least one electrode into the electrolyte contacting the at least one electrode, the second voltage being greater than the first voltage, the cycling including
increasing the applied voltage from the first voltage to the second voltage to cause at least a portion of the metal of the at least one electrode to oxidize to form a metal oxide, and
decreasing the applied voltage from the second voltage to the first voltage subsequently to increasing the applied voltage from the first voltage to the second voltage and concurrently with the electrolyte contacting the at least one electrode to cause at least a portion of the metal oxide to reduce to metal and to separate from the at least one electrode into the electrolyte as the at least one metal particle.

2. The metal injection system of claim 1, wherein the metal includes at least one of platinum, gold, palladium, rhodium, ruthenium, osmium, silver, iridium, titanium, zinc, nickel, iron, or any combination thereof.

3. A nuclear power plant, comprising:
a nuclear reactor, the nuclear reactor including nuclear reactor process equipment, the nuclear reactor process equipment including at least one of a reactor pressure vessel or a nuclear reactor core within the reactor pressure vessel, the nuclear reactor process equipment including a nuclear reactor process equipment surface at least partially defining an electrolyte flow pathway extending at least partially through the nuclear reactor, the nuclear reactor process equipment configured to circulate a coolant configured to be an electrolyte through the electrolyte flow pathway to contact the nuclear reactor process equipment surface; and
the metal injection system of claim 1, wherein the at least one electrode of the metal injection system is exposed to at least a portion of the electrolyte flow pathway such that the nuclear power plant is configured to circulate at least a portion of the electrolyte to flow in contact with the at least one electrode, the electrolyte flow pathway includes a coolant circuit configured to circulate the coolant through the nuclear reactor,
wherein the controller of the metal injection system is configured to cycle the voltage between the first voltage and the second voltage over the period of time, concurrently with the electrolyte circulating through the coolant circuit, to induce separation of the at least one metal particle from the at least one electrode into the electrolyte contacting the at least one electrode and to further cause the at least one metal particle to deposit at at least one nuclear reactor process equipment surface based on the electrolyte carrying the at least one metal particle through at least a portion of the coolant circuit.

4. The nuclear power plant of claim 3, wherein the at least two electrodes are within the reactor pressure vessel.

5. The nuclear power plant of claim 3, wherein
the coolant is water, and
the nuclear power plant is configured to circulate the water through the coolant circuit such that a temperature of water in contact with the at least one electrode is equal to a temperature of water entering the reactor pressure vessel.

6. The nuclear power plant of claim 5, wherein the water in contact with the at least one electrode is at a temperature between 220° C. and 340° C.

7. The nuclear power plant of claim 3, wherein the nuclear power plant includes at least two flow control valves are configured to be operated to isolate the at least one electrode from at least a portion of the electrolyte flow pathway and the nuclear reactor process equipment.

8. The nuclear power plant of claim 3, wherein
the coolant circuit includes a feedwater pipe configured to direct coolant into the reactor pressure vessel, and
the at least one electrode is within the feedwater pipe.

9. The nuclear power plant of claim 3, wherein the nuclear reactor is a boiling water reactor.

10. The nuclear power plant of claim 3, wherein the nuclear reactor is a pressurized water reactor.

11. A method of releasing metal particles into a coolant configured to be an electrolyte such that the coolant is configured to carry the metal particles through at least a portion of nuclear process equipment to further enable deposition of the metal particles at at least one at least one nuclear process equipment surface of the nuclear process equipment that is exposed to the electrolyte, the method of releasing the metal particles comprising:
contacting at least two electrodes with the electrolyte within an electrolyte flow pathway that is at least partially defined by the at least one nuclear process equipment surface of the nuclear process equipment, at least one electrode of the at least two electrodes including the metal;
circulating the electrolyte through the electrolyte flow pathway such that the at least two electrodes are contacted by the electrolyte flowing through the electrolyte flow pathway and the electrolyte flowing through the electrolyte flow pathway are in fluid communication with the at least one nuclear process equipment surface;
applying a voltage of electrical power to the at least two electrodes from a power source connected to each electrode of the at least two electrodes; and
controlling the voltage of electrical power applied from the power source to the at least two electrodes such that the voltage cycles between a first voltage and a second voltage over a period of time to induce separation of at least one metal particle from the at least one electrode into the electrolyte contacting the at least one electrode, the second voltage being greater than the first voltage, the cycling including,
increasing the applied voltage from the first voltage to the second voltage to cause at least a portion of the metal of the at least one electrode to oxidize to form a metal oxide, and
decreasing the applied voltage from the second voltage to the first voltage subsequently to increasing the applied voltage from the first voltage to the second voltage and concurrently with the electrolyte contacting the at least one electrode to cause at least a portion of the metal oxide to reduce to metal and to separate from the at least one electrode into the electrolyte as the at least one metal particle.

12. The method of claim 11, wherein the metal includes at least one of platinum, gold, palladium, rhodium, ruthenium, osmium, silver, iridium, titanium, zinc, nickel, iron, or any combination thereof.

13. The method of claim 11, wherein the circulating and the controlling are performed concurrently to induce separation of the at least one metal particle from the at least one electrode into the electrolyte contacting the at least one electrode and to further cause the at least one metal particle to deposit at the at least one nuclear process equipment surface based on the electrolyte carrying the at least one metal particle through at least a portion of the electrolyte flow pathway.

14. The method of claim 13, wherein
the nuclear process equipment includes a nuclear reactor, the nuclear reactor including at least one of a reactor pressure vessel or a nuclear reactor core within the reactor pressure vessel,
the electrolyte flow pathway includes a coolant circuit that circulates a coolant through the nuclear reactor,
the electrolyte includes the coolant within the coolant circuit,
the at least one nuclear process equipment surface includes a nuclear reactor surface of the nuclear reactor that is exposed to the coolant based on circulation of the coolant through the nuclear reactor, and
the controller cycles the voltage between the first voltage and the second voltage over the period of time, concurrently with the coolant circulating through the coolant circuit, inducing separation of the at least one metal particle from the at least one electrode into the coolant contacting the at least two electrodes and further cause the at least one metal particle to deposit at the nuclear reactor surface based on the coolant carrying the at least one metal particle through at least a portion of the nuclear reactor.

15. The method of claim 14, wherein the at least two electrodes are within the reactor pressure vessel.

16. The method of claim 14, wherein the nuclear reactor is a boiling water reactor.

17. The method of claim 14, wherein the nuclear reactor is a pressurized water reactor.

18. The method of claim 14, wherein
the coolant is water, and
the water in contact with the at least two electrodes is at a temperature between 220° C. and 340° C.

19. The method of claim 14, wherein
the coolant circuit includes a feedwater pipe configured to direct coolant into the reactor pressure vessel, and
the at least two electrodes are within the feedwater pipe.

20. A method for assembling a metal injection system, the method comprising:
obtaining a metal injection system configured to release at least one metal particle into a coolant configured to be an electrolyte such that the coolant is configured to carry the at least one metal particle through at least a portion of nuclear process equipment to further enable deposition of the at least one metal particle at at least one nuclear process equipment surface of the nuclear process equipment that is exposed to the electrolyte for use in a nuclear power plant; and
inserting the metal injection system into a coolant circuit for the nuclear power plant,
the metal injection system including,
at least two electrodes, at least one electrode of the at least two electrodes including the metal, the at least one electrode configured to be exposed in flow communication with at least a portion of an electrolyte flow pathway that is at least partially defined by the at least one nuclear process equipment surface of the nuclear process equipment and is configured to circulate the electrolyte to contact the at least one nuclear process equipment surface of the nuclear process equipment, such that the at least one electrode is configured to be contacted by at least a portion of the electrolyte flowing through the electrolyte flow pathway to further flow in fluid communication with the at least one nuclear process equipment surface,
a power source connected to each electrode of the at least two electrodes; and
a controller configured to control a voltage of electrical power applied from the power source to the at least two electrodes, the controller is configured to cycle the voltage between a first voltage and a second voltage over a period of time to induce separation of at least one metal particle from the at least one electrode into the electrolyte contacting the at least one electrode, the second voltage being greater than the first voltage, the cycling including
increasing the applied voltage from the first voltage to the second voltage to cause at least a portion of the metal of the at least one electrode to oxidize to form a metal oxide, and
decreasing the applied voltage from the second voltage to the first voltage subsequently to increasing the applied voltage from the first voltage to the second voltage and concurrently with the electrolyte contacting the at least one electrode to cause at least a portion of the metal oxide to reduce to metal and to separate from the at least one electrode into the electrolyte as the at least one metal particle.
